(19) United States
(12) Patent Application Publication
(10) Pub. No.: US 2025/0239241 A1
(43) Pub. Date: Jul. 24, 2025

(54) METHOD AND APPARATUS FOR SYNTHESIZING A SINGING VOICE, ELECTRONIC DEVICE AND PROGRAM PRODUCT

(71) Applicant: Beijing Zitiao Network Technology Co., Ltd., Beijing (CN)

(72) Inventor: Yiqing LU, Beijing (CN)

(21) Appl. No.: 18/970,480

(22) Filed: Dec. 5, 2024

(30) Foreign Application Priority Data
Jan. 22, 2024 (CN) 202410090755.9

(51) Int. Cl. G10H 1/00; G10L 13/033

(52) U.S. Cl. CPC G10H 1/0008; G10L 13/0335; G10H 2250/455

(57) ABSTRACT

Embodiments of the present disclosure relate to a method and apparatus for synthesizing a singing voice, an electronic device and a program product. The method comprises obtaining a musical score file with breath-taking identifiers, and segmenting the musical score file into a plurality of musical score segments based on the breath-taking identifiers. The method further comprises generating a plurality of audio segments corresponding to the plurality of musical score segments, and synthesizing a singing voice corresponding to the musical score file based on the plurality of audio segments. In an embodiment of the present disclosure, the musical score file is segmented into a plurality of musical score segments according to the breath-taking identifier, a plurality of audio segments corresponding to the plurality of musical score segments are generated, and finally, a singing voice corresponding to the musical score file is synthesized based on the plurality of audio segments.

### CROSS-REFERENCE TO RELATED APPLICATION(S)

This application claims priority to Chinese Application No. 202410090755.9 filed Jan. 22, 2024, the disclosure of which is incorporated herein by reference in its entity.

### FIELD

Embodiments of the present disclosure relate to the technical field of synthesis of a singing voice, and more specifically to a method and apparatus for synthesizing a singing voice, an electronic device and a program product.

### BACKGROUND

The singing voice synthesizing technique is a technique for generating a human singing voice using a computer algorithm and a voice processing technique. Based on the principle of audio signal processing, the singing voice synthesizing technique aims to create a high-quality singing voice by simulating the voice and expression manner of a human singer.

At present, the singing voice synthesizing technique has made great progress, may generate a high-quality singing voice, and has been widely used in fields such as music production and virtual singers. With the singing voice synthesizing technique, people can easily create singing voices very similar to real human voices, thus providing more possibilities for music production and creation. With the continuous progress of the technique and the expansion of application scope, the singing voice synthesizing technique is expected to play a greater role in the future.

### SUMMARY

Embodiments of the present disclosure provide a method and apparatus for synthesizing a singing voice, an electronic device and a program product.

According to a first aspect of the present disclosure, there is provided a method for synthesizing a singing voice. The method comprises obtaining a musical score file with breath-taking identifiers. The method further comprises segmenting the musical score file into a plurality of musical score segments based on the breath-taking identifiers. The method further comprises generating a plurality of audio segments corresponding to the plurality of musical score segments. In addition, the method further comprises synthesizing a singing voice corresponding to the musical score file based on the plurality of audio segments.

According to a second aspect of the present disclosure, there is provided an apparatus for synthesizing a singing voice. The apparatus comprises a musical score file obtaining module configured to obtain a musical score file with breath-taking identifiers. The apparatus further comprises a musical score file segmenting module configured to segment the musical score file into a plurality of musical score segments based on the breath-taking identifiers. The apparatus further comprises an audio segment generating module configured to generate a plurality of audio segments corresponding to the plurality of musical score segments. In addition, the apparatus further comprises a singing voice synthesizing module configured to synthesize a singing voice corresponding to the musical score file based on the plurality of audio segments.

According to a third aspect of the present disclosure, there is provided an electronic device. The electronic device comprises: a processor; and a memory coupled to the processor, the memory having stored therein instructions that, when executed by the processor, cause the electronic device to perform the method in the first aspect.

According to a fourth aspect of the present disclosure, there is provided a computer program product. The computer-readable storage medium has stored thereon computer-executable instructions, wherein the computer-executable instructions are executed by a processor to implement the method according to the first aspect.

This Summary is provided to introduce a selection of concepts that will be further described in Detailed Description of Embodiments below. This Summary is not intended to identify key features or essential features of the present disclosure or limit the scope of the present disclosure.

### BRIEF DESCRIPTION OF THE DRAWINGS

The above and other features, advantages and aspects of the embodiments of the present disclosure will be more apparent in conjunction with the drawings and with reference to the following detailed depictions. The same or similar reference numerals throughout the drawings represent the same or similar elements.

FIG. 1 illustrates a schematic diagram of an example environment in which some embodiments of the present disclosure may be implemented;

FIG. 2 illustrates a flow diagram of a method for synthesizing a singing voice according to some embodiments of the present disclosure;

FIG. 3 illustrates a schematic diagram for synthesizing a singing voice according to some embodiments of the present disclosure;

FIG. 4 illustrates a schematic diagram optionally for synthesizing a singing voice according to some embodiments of the present disclosure;

FIG. 5 illustrates a schematic diagram for training a breath-taking identifier prediction model according to some embodiments of the present disclosure;

FIG. 6 illustrates a schematic diagram for segmenting musical score segments according to some embodiments of the present disclosure;

FIG. 7 illustrate a schematic diagram for adding a symbol at both the beginning and ending of a musical score segment according to some embodiments of the present disclosure;

FIG. 8 illustrates a block diagram of an apparatus for synthesizing a singing voice according to some embodiments of the present disclosure; and

FIG. 9 illustrates a block diagram of an electronic device according to some embodiments of the present disclosure.

Throughout the drawings, the same or like reference numerals denote the same or like elements.

### DETAILED DESCRIPTION OF EMBODIMENTS

It may be appreciated that the data (including but not limited to the data itself, acquisition or use of the data) involved in the technical solutions shall meet requirements of corresponding laws, regulations and relevant provisions.

It may be appreciated that prior to using the technical solutions disclosed in various embodiments of the present disclosure, a user should be notified of the type, scope of use, use scenario, etc. of personal information involved in the present disclosure and authorization be obtained from the user in an appropriate manner according to relevant laws and regulations.

For example, in response to reception of the user's active request, prompt information is sent to the user to explicitly prompt the user that an operation he requests to perform needs to obtain and use the user's personal information. Accordingly, the user may autonomously select, according to the prompt information, whether to provide the personal information to software or hardware such as an electronic device, an application, a server or a storage medium, which executes the operation of the technical solution of the present disclosure.

As an alternative but non-limiting implementation, in response to reception of the user's active request, the prompt message may be sent to the user, for example, in the form of a pop-up window in which the prompt information may be presented in a text. In addition, the pop-up window may further carry a selection control for the user to select “agree” or “disagree” to provide the personal information to the electronic device.

It is to be understood that the above-described processes of notifying and obtaining the user's authorization are merely illustrative and not be construed as limiting the implementations of the present disclosure, and that other ways of satisfying relevant laws and regulations may also be applied to the implementations of the present disclosure.

Embodiments of the present disclosure will be described in detail below with reference to the accompanying drawings. Although the drawings show some embodiments of the present disclosure, it should be understood that the present disclosure can be implemented in various forms and should not be construed as being limited to the embodiments described herein. Instead, the embodiments are provided for a more thorough and complete understanding of the present disclosure. It should be understood that the drawings and the embodiments in the present disclosure are for illustrative purpose only, and are not intended to limit the protection scope of the present disclosure.

In the depictions of the embodiment of the present disclosure, the term “including” and variants thereof as used herein are open-ended, that is, “including but not limited to”. The term “based on” means “based at least in part on.” The term “an embodiment” or “the embodiment” means “at least one embodiment”. Terms such as “first” and “second” may refer to different or same objects, unless otherwise expressly specified. Other explicit or implicit definitions might also be included in the text below.

In the conventional singing voice synthesizing techniques, a traditional method usually depends on a rest symbol (e.g., a long rest symbol) extracted from a musical score file to segment the musical score, but does not fully take into count the breath-taking voice produced in real singing. This causes some unnatural phenomena to occur when the singing voice is synthesized, e.g., a prolonged voice might occur at some parts, whereas a breath holding phenomenon might occur at other parts, which significantly affects the overall auditory perception of the listeners.

In an embodiment of the present disclosure, a musical score file with breath-taking identifiers is obtained, the musical score file is segmented into a plurality of musical score segments according to the breath-taking identifier, a plurality of audio segments corresponding to the plurality of musical score segments are generated, and finally, a singing voice corresponding to the musical score file is synthesized based on the plurality of audio segments. The musical score file is segmented according to the singer's actual breathing rhythm, and the whole singing voice segment is synthesized by converting the corresponding musical score segment into a corresponding audio segment, so that tone and intonation when a real singer sings can be better simulated. Such a method of synthesizing a singing voice may avoid musical note prolonging or breath-holding phenomenon occurring in the synthesis of the singing voice by a conventional method, so that the synthesized singing voice is much smooth and natural and the user's experience may be enhanced.

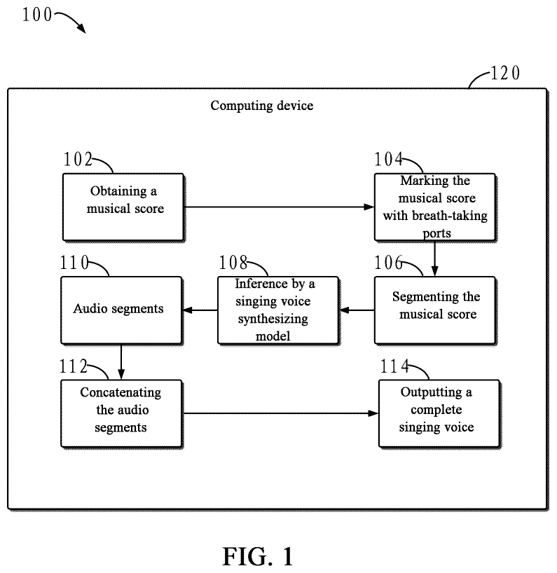

FIG. 1 illustrates a schematic diagram of an example environment 100 in which some embodiments of the present disclosure may be implemented. As shown in FIG. 1, the example environment 100 may be configured as a computing device 120, wherein the computing device 120 may be configured as a computing system, a single server, a distributed server, or a cloud-based server, etc., or as a user terminal, a mobile device, a computer, etc., or as a combination of the forgoing devices.

Referring to FIG. 1, a computing device 120 obtains a musical score file at 102. In some embodiments, the computing device 120 may obtain the musical score file via a wired transmission, a wireless transmission, a Bluetooth transmission, an infrared transmission or the like. The musical score file is a file for recording music melody and rhythm, and generally adopts a symbol system such as staff or numbered musical notation to record elements such as pitch, duration and intensity of the music. The present disclosure relates to a musical score in musical forms, such as a staff score, a numbered musical score or a gongche notation score, etc. In the musical score file, musical notes are recorded on the score, and musical elements such as pitch, duration, strength, etc. are represented by different symbols and marks. These files may be used in the fields such as music creation, rehearsal, performance and teaching. The musical score is a musical symbolic language, represents music by symbols, numbers or patterns etc., and may record various forms of music, so as to help the composer or reader better understand the music works, and provide specific guidance and help for music creators and players.

In some embodiments, the format of the musical score file is musical instrument digital interface (MIDI) format, music XML format, etc. The MIDI format, as a digital music interface format, is used to record musical notes and rhythm information of music, and may be used for application such as music production and automatic performance. The MusicXML is a music file format based on Extensible Markup Language (XML), and may be used for music layout, publishing, digital music production etc. In some embodiments, the musical score file includes a musical score file containing Chinese lyrics or a musical score file containing foreign language lyrics. In some embodiments, the musical score file may be any entire song or any song segment within the entire song.

Further referring to FIG. 1, after obtaining the musical score file, the computing device 120 parses at 104 to know that the musical score file is marked with a breath-taking port, wherein the breath-taking port is an identification of the breath-taking voice when a human singer actually sings. When a singer sings, the magnitude and expression manner of the breath-taking voice is also one of the important criteria for judging the singer's singing skills. Some singers may improve their performance skills by reducing the breath-taking voice or controlling the expression manner of the breath-taking voice through special breathing exercises and vocal training.

In some embodiments, the breath-taking port may be derived by way of model reasoning. For example, the breath-taking port may be predicted by using a breath-taking prediction identification model, and a breath-taking identifier is marked on the musical score file. In some embodiments, some breath-taking identifiers are manually marked. These musical score files, which are already marked with breath-taking identifiers, are usually used by singers to help them better plan their inhalation and exhalation and breathing, to remind them of the details that they need to pay attention to in their singing, and to show the expression manners to be noticed in the performance. In some embodiments, the breath-taking port is a position of a pause prompted by a rest symbol, and is a personal breath-taking point mastered by a human singer to perform the song.

Further referring to FIG. 1, the computing device 120 segments the musical score file into a plurality of musical score segments according to the breath-taking port at 106. With further reference to FIG. 1, after obtaining the plurality of musical score segments, the computing device performs a singing voice synthesizing model inference 108 to input the duly-segmented plurality of musical score segments into a singing voice synthesizing model for inference to obtain audio segments 110. In some embodiments, before the musical score segments are inputted into the singing voice synthesizing model for inference, a symbol is added at the beginning and ending of each audio segment, i.e., the breath-taking symbol is added at the beginning to enable the synthesized audio segment to have a more natural breath-taking rhythm.

In some embodiments, the singing voice synthesizing model may include but not limited to a single one or a combination of multiple ones of various singing voice synthesizing models. In some embodiments, before the singing voice synthesizing model inference 108 is performed, data of the musical score file is extracted and pre-processed, for example, features such as lyrics, phonemes and notes are extracted from the musical score filed, and these features are cleaned to obtain clean data to facilitate subsequent model training.

Further referring to FIG. 1, after generating the plurality of audio segments, the computing device concatenates the audio segments at 112 to concatenate the plurality of audio segments into a complete audio segment. In some embodiments, when audio segments are concatenated, a manner of concatenating the audio segments is selected according to different policies. For example, if the ending of the previous segment of the current segment is a long tone, the breath-taking voice of the current segment covers part of the long tone of the previous segment. Turning back to FIG. 1, after performing processing according to concatenating policy, the computing device 120 outputs a complete singing voice at 114. At this time, the listener may experience a complete synthesized singing voice which is consistent with the natural degree of live singing of a real singer and is comfortable in rhythm, thereby enhancing the user's experience.

In the embodiment of the present disclosure, the musical score file marked with breath-taking identifiers is obtained, the musical score file is segmented into a plurality of musical score segments according to the breath-taking identifiers, a plurality of audio segments corresponding to the plurality of musical score segments are generated, and then the singing voice corresponding to the musical score file is synthesized based on the plurality of audio segments. The musical score file is segmented according to the singer's actual breathing rhythm, the segmented musical score segments are input into the singing voice synthesizing model for inference to obtain audio segments, and the audio segments are synthesized as a complete singing voice. The thus-synthesized singing voice may better simulate the tone and intonation when a real singer sings, and be much smooth and natural and thereby enhance the listener's experience.

It should be understood that the architecture and functionality in the example environment 100 are described for exemplary purposes only and do not imply any limitation on the scope of the present disclosure. The embodiment of the present disclosure may also be applied to other environments having different structures and/or functions.

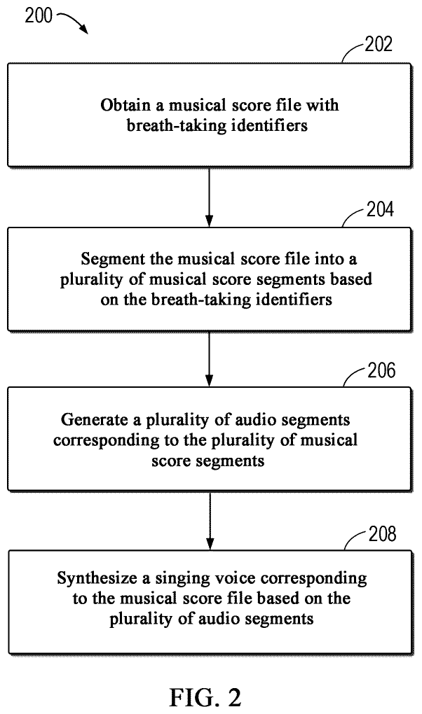

Hereinafter, a process according to an embodiment of the present disclosure will be described in detail with reference to FIG. 2 through FIG. 11. To facilitate understanding, specific data mentioned in the following description is exemplary and is not intended to limit the scope of the present disclosure. It is to be understood that the embodiments described below may also include additional acts not shown and/or the shown acts may be omitted, and the scope of the present disclosure is not limited in this respect.

FIG. 2 illustrates a flow diagram of a method 200 for synthesizing a singing voice according to some embodiments of the present disclosure. At block 202, a musical score file with breath-taking identifiers is obtained. In some embodiments, the musical score file has been manually marked with breath-taking identifiers. Alternatively, the breath-taking identifiers are obtained by model inference, e.g., obtained by using a breath-taking identifier prediction model, and the breath-taking identifiers are marked in the musical score file. In some embodiments, the breath-taking identifiers may include rest symbols.

At block 204, the musical score file is segmented into a plurality of musical score segments based on the breath-taking identifiers. The musical score file marked with the breath-taking identifiers is segmented into the plurality of musical file segments to facilitate the subsequent inference work via a singing voice synthesizing model. In some embodiments, a breath-taking symbol is added at the beginning of each musical score segment, and a silence symbol is added at the ending of the musical score segment. As such, it is possible to ensure that the synthesized singing voice finally has a breath-taking effect, enhance the natural degree and smoothness of the synthesized singing voice, and also match a training phase of the singing voice synthesizing model.

At block 206, a plurality of audio segments corresponding to the plurality of musical score segments are generated. In some embodiments, the audio segments are obtained by inputting the musical score segments into the singing voice synthesizing model for inference. In some embodiments, before the inference is performed for the musical score segments, the musical score segments are first parsed, e.g., musical symbols and information are extracted from the musical score segments by using a musical score parsing tool or algorithm so as to enable the computing device to understand and process the format of the data.

In some embodiments, after the musical score segments are parsed, phoneme features of pitch, duration and intensity are extracted from the parsed data. In sound synthesis, a phoneme refers to the smallest phonetic unit or smallest phonetic segment that makes up a syllable, and is divided from the perspective of timbre. Musical notes are symbols for recording tones of different lengths, and the rhythm and melody of music may be arranged according to the length and the duration of the musical notes. In sound synthesis, lyrics may match melodies and musical notes to jointly constitute a complete singing voice.

In some embodiments, a phoneme sequence of the musical score segments is determined according to the extracted phoneme features. The phoneme sequence refers to a sequence in which phonemes in a speech signal are arranged in a certain order. The phoneme sequence comprises interval information about adjacent phonemes. The interval information about adjacent phonemes refers to a time interval or duration difference between two adjacent phonemes. In some embodiments, the phoneme features are converted to spectral features, e.g., to a Mel spectrum in the frequency domain. As such, the local information of the speech signal may be better used. The Mel frequency is approximation of the way a human ear perceives frequency. The conversion between the Mel frequency and the linear frequency may be completed by a Mel frequency scaling formula. A Mel spectrogram better simulates the human ears' perception of sound by using a Mel scale on the frequency axis of the spectrogram. In some embodiments, a corresponding musical score segment is generated based on the duly-converted spectral features and the phoneme sequence. In some embodiments, the musical score segment is segmented into individual characters and the phonemes of the individual characters are determined according to the parts of speech of the individual characters and the meaning of the individual characters. For example, the character “ [symbol] (return)” in “ [symbol] (return something)” is a verb and means “give something back”. In this case, the character “ [symbol] ” should read “huan” not “huai”.

At block 208, a singing voice corresponding to the musical score file is synthesized based on the plurality of audio segments. In some embodiments, before the segments are concatenated, the audio segments may be concatenated according to a pre-defined policy. For example, if a long tone occurs at the ending of the current segment, a choice is made to enable the breath-taking voice of next synthesized audio segment of the current synthesized audio segment partly covers the long-tone segment to keep natural transition of the tone. For example, if the current synthesized audio segment and its preceding synthesized audio segment are both continuous singing voices without occurrence of pauses, the two segments may be superimposed and concatenated in a fade-in and fade-out manner. For example, when the preceding synthesized audio segment is a rest symbol segment, the breath-taking voice of the current synthesized audio segment partly covers the rest symbol segment to maintain sound consistency. In this way, it can be ensured that the synthesized audio maintains the original breath-taking effect of a real singer's singing after the concatenation, and meanwhile the length of the synthesized audio is kept consistent with the original length of the song.

In the present embodiment, the musical score file is segmented into a plurality of segments according to the obtained musical score file with the breath-taking identifiers, a plurality of audio segments are generated based on these musical score segments, then these audio segments are concatenated into a complete segment, and finally a complete singing voice is output. The musical score file is segmented according to the singer's actual breathing rhythm. The thus-synthesized singing voice may better simulate the tone and intonation when a real singer sings, and be more smooth and natural and thereby enhance the listener's experience. Thereby the method 100 prevents phenomena such as unnatural breath-holding or tone dragging from occurring in the synthesized singing voice, better restores the tone and intonation when a real singer sings, and improves the listening experience of the listeners

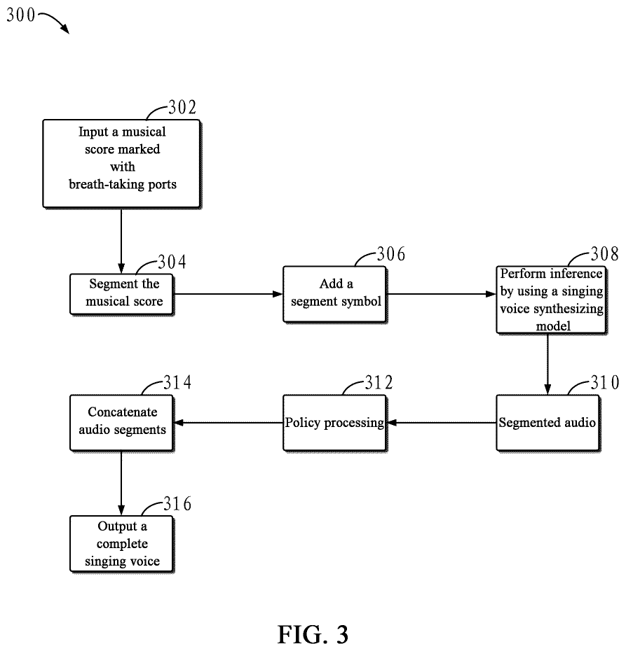

FIG. 3 illustrates a schematic diagram for synthesizing a singing voice 300 according to some embodiments of the present disclosure. Referring to FIG. 3, the user inputs the musical score file to be synthesized into a singing voice into the computing device through the musical score 302 with the breath-taking ports. In some embodiments, these breath-taking ports of in the musical score file are manually marked. In some embodiments, the user may input the musical score file with the breath-taking ports into the computing device in a wireless or wired manner or via an Application Programming Interface (API). The computing device segments the musical score file at 304. The computing device segments the musical score file into a plurality of musical score segments according to the breath-taking ports marked in the musical score file. Then, segment symbols are added at 306. In some embodiments, a breath-taking symbol is added at the beginning of the duly-segmented segment, and a silence symbol is added at the ending of the duly-segmented segment. As such, each musical score segment may have a good breath-taking effect so that the finally-synthesized singing voice sounds comfortable and natural in rhythm, and furthermore, the way of adding symbols at the beginning and ending facilitates the smooth performance of the subsequent inference via the singing voice synthesizing model.

Further referring to FIG. 3, the computing device continues to perform inference via the singing voice synthesizing model at 308. In some embodiments, before the musical score segments are input to the singing voice synthesizing model for inference, the musical score file is parsed. For example, the musical symbols and information are extracted from the musical score file by using a musical score parsing tool, information such as phonemes, musical notes and lyrics is extracted from the data after the parsing, and cleaning, format conversion and feature extraction are performed on these data. Segmented audios corresponding to the musical score segments are output at 310 after the inference of the model.

As shown in FIG. 3, at 312, policy processing is performed: the generated audio segments corresponding to the musical score segments are processed based on a predetermined concatenating policy. In some embodiments, if the current synthesized audio segment and its preceding synthesized audio segment are both continuous singing voices without pauses, the two synthesized audio segments may be superimposed and concatenated in a fade-in and fade-out manner. In some embodiments, if a long tone occurs at the ending of the synthesized audio segment preceding the current synthesized audio segment, the breath-taking voice of the current synthesized audio segment partly covers the long tone segment. In some embodiments, if the synthesized audio segment preceding the current synthesized audio segment is a rest symbol segment, the breath-taking segment of the current synthesized audio segment partly covers the rest symbol segment. In this way, it can be ensured that the audio segments reserve the breath-taking effect when being concatenated so that the synthesized audio segment has an effect like singing effect of a real singer, and meanwhile it can be ensured that the length of the synthesized singing voice is kept consistent with the original length of the song.

At 314, a complete audio segment is obtained by concatenating all the processed synthesized audio segments. At 316, the computing device will output a complete synthesized singing voice. As such, the phenomena such as breath-holding and long tone without a pause which occur in the traditional synthesis of the singing voice are avoided, and the user experience the listening feeling of the synthesized singing voice as a real singer sings.

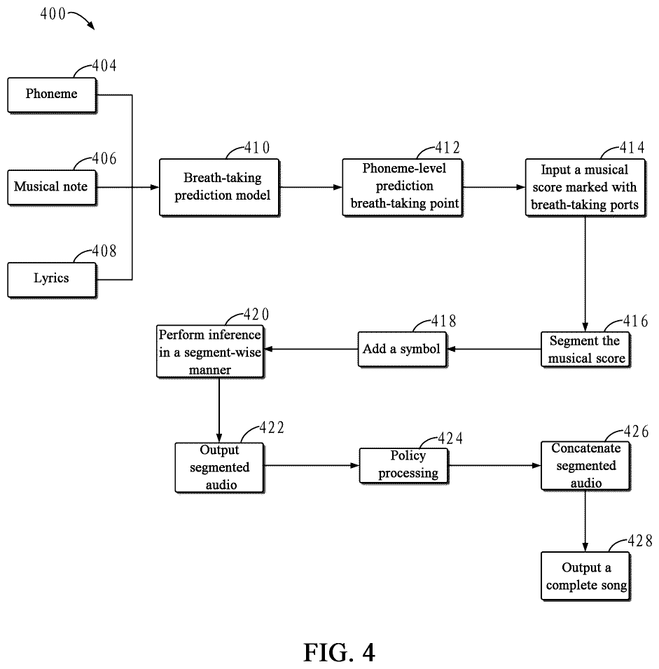

FIG. 4 illustrates a schematic diagram optionally for synthesizing a singing voice 400 according to some embodiments of the present disclosure. Referring to FIG. 4, a phoneme 404, a musical note 406 and lyrics 408 are input to a breath-taking prediction model 410 to obtain a phoneme-level prediction breath-taking point 412. The phoneme generally refers to the smallest recognizable unit of sound in music, such as a pitch, duration, etc. The musical note refers to a specific musical symbol, such as a full note, a half note, etc. The lyrics is a word part of the song. In some embodiments, before the phoneme, musical note, and lyrics information are extracted, the musical score file is parsed using a musical score parsing file to facilitate subsequent feature extraction. In some embodiments, the phoneme, musical note and lyrics are input into the breath-taking prediction model at the phoneme level. For example, [phone1, phone2, phone3, phone4, phone5, phone6, phone7, phone8] are input into the breath-taking identifier prediction model, and a prediction sequence [0, 0, 0, 1, 0, 0, 1, 0] with the same length will be output, wherein 1 represents a breath-taking identifier, and 0 represents no breath-taking. The output prediction sequence is analyzed and the musical score file is identified according to the breath-taking points therein.

Further referring to FIG. 4, at 414, a musical score with breath-taking ports is input. The musical score file with the breath-taking ports is input to the computing device. At 416, the musical score is segmented. The computing device will segment the musical score file according to the breath-taking ports marked in the musical score file to obtain a plurality of musical score segments. At 418, symbols are added: a breath-taking symbol is added at the beginning of each musical score segment, and a silence symbol is added at the ending of each musical score segment. At 420, inference is performed in a segment-wise manner: the segments to which the breath-taking symbols and silence symbols are added are input to the singing voice synthesizing model. At 422, the synthesized audio segments are output to obtain the synthesized audio segments corresponding to the musical score segments.

Further referring to FIG. 4, at 424, policy processing is performed: the obtained synthesized audio segments are processed according to a pre-defined policy. In some embodiments, if the current synthesized audio segment and its preceding synthesized audio segment are both continuous singing voices without pauses, the two synthesized audio segments may be superimposed and concatenated in a fade-in and fade-out manner. In some embodiments, if a long tone occurs at the ending of the synthesized audio segment preceding the current synthesized audio segment, the breath-taking voice of the current synthesized audio segment partly covers the long tone segment. In some embodiments, if the synthesized audio segment preceding the current synthesized audio segment is a rest symbol segment, the synthesized breath-taking segment of the current synthesized audio segment partly covers the rest symbol segment. As such, it can be ensured that the breath-taking effect after the concatenation of the synthesized audio segments is optimized. At 426, the concatenation of all the synthesized audio segments after the policy processing is completed. At 428, a complete synthesized song is output. The duration of the complete synthesized audio segment after such processing is consistent with the duration of the audio corresponding to the musical score file, the original length of the synthesized song is ensured invariable, and a synthesized singing voice with an ideal inhaling effect is finally obtained.

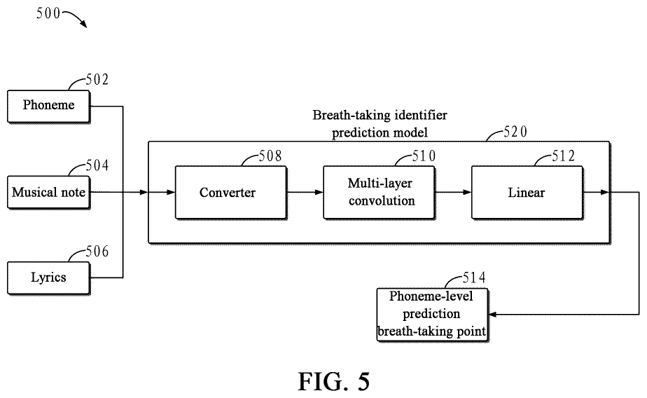

FIG. 5 illustrates a schematic diagram for training a breath-taking identifier prediction model 500 according to some embodiments of the present disclosure. Referring to FIG. 5, the structure of the breath-taking identifier prediction model 520 at least comprises a converter 508, a multi-layer convolution layer 510, and a linear layer 512. The converter uses an attention mechanism to improve a model training speed. The converter consists of an input encoder and an output decoder which are connected by several self-attention layers. These layers use the attention mechanism to calculate a relationship between the inputs and the output, thereby allowing the converter model to process sequences in parallel.

The multi-layer convolution layer refers to a model comprising a plurality of convolution layers in a convolutional neural network. Each convolution layer will add some non-linear operations, such as an activation function, batch normalization, etc. to increase the complexity and expression capability of the model. The linear layer is also referred to as a fully-connected layer or a dense layer. Each neuron in the linear layer is connected to all neurons of the previous layer to implement a linear combination or linear transformation of the previous layer. In some embodiments, before the musical score file is input into the breath-taking identifier prediction model, the musical score file will be parsed using a musical score parsing tool to obtain phoneme, musical note, and lyrics features associated with the musical score file.

Further referring to FIG. 5, a phoneme 502, a musical note 504 and lyrics 506 are input to a breath-taking identifier prediction model to implement a phoneme-level prediction breath-taking point. In some embodiments, the phoneme, musical note and lyrics are input into the breath-taking identifier prediction model at the phoneme level, a prediction sequence with the same length is obtained, and the prediction sequence includes a breath-taking prediction identifier. In some embodiments, the extracted phoneme features, musical note features and lyrics features are input into the breath-taking identifier prediction model in a vector-embedded manner to obtain a 0/1 vector with the same length as the phoneme as a prediction value of the breath-taking point. In some embodiment, the phoneme, musical note and lyrics respectively undergo the three models to obtain a 0/1 vector with the same length as the phoneme as a prediction value of the breath-taking point. For example, [phone1, phone2, phone3, phone4, phone5, phone6, phone7, phone8] are input into the breath-taking identifier prediction model, and the model will output a prediction sequence [0, 0, 0, 1, 0, 0, 1, 0] with the same length, wherein 1 represents a breath-taking identifier, and O represents a non-breath-taking state.

Further referring to FIG. 5, the breath-taking identifier prediction model is trained using the file marked with the breath-taking identifiers. Specifically, the musical score file without the breath-taking identifiers is input into the breath-taking identifier prediction model for training, and the breath-taking identifier prediction model will output a phoneme sequence having breath-taking identifiers. The breath-taking identifier prediction model is adjusted by comparing the generated phoneme sequence with a label sequence having breath-taking prediction markings. For example, after the musical score file without the breath-taking identifiers is input to the model, the sequence generated by the model is [0,0,0,1,0,0,0], and the label sequence is [0,0,1,1,0,0,0], a loss between the generated sequence and the label sequence is compared, for example, the loss between the generated sequence and the tag sequence is calculated through the mean square error, mean absolute error, or cross entropy loss.

In some embodiments, parameters of the breath-taking identifier prediction model 520 are adjusted according to the loss. For example, if the loss is too large or too small, model parameters such as a learning rate and a regularization coefficient may be adjusted to optimize the performance of the model, and better model parameters may be obtained by iterative training. In some embodiments, if a corresponding loss convergence condition satisfied by the loss, i.e., the value of the loss function, gradually becomes stable and tends to be stable, it is determined that the model stops being trained, whereupon the model may proceed to the next prediction and inference. In some embodiments, before the model is trained, work such as data cleaning and data annotation is performed on the training samples of the model. The manpower and time costs may be saved by predicting breath-taking points in the musical score file through the breath-taking identifier prediction model.

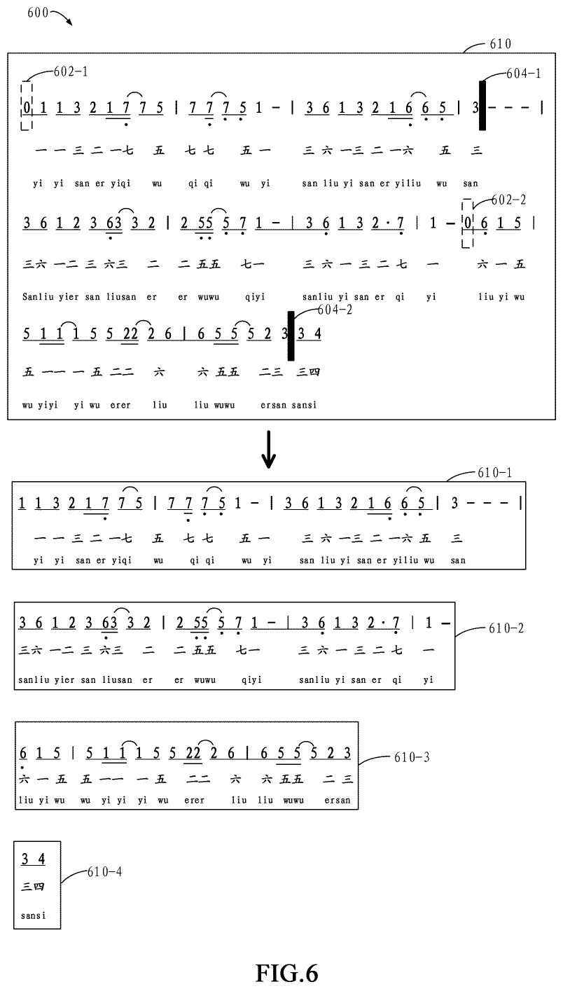

FIG. 6 illustrates a schematic diagram for segmenting 600 musical score segments according to some embodiments of the present disclosure. As shown in FIG. 6, a musical score file 610 includes a rest symbol 602-1 and a rest symbol 602-2. A breath-taking identifier 604-1, a breath-taking identifier 604-2, the rest symbol 602-1 and the rest symbol 602-1 are obtained by manually marking or by performing inference using the breath-taking identifier prediction model. In some embodiments, the musical score file is segmented according to the breath-taking identifiers. Alternatively, the musical score segments may also be segmented according to the rest symbols at the same time.

In some embodiments, the rest symbol is also the breath-taking identifier point. In some embodiments, the breath-taking identifier is a rhythm point where a human singer pauses to take a breath upon singing. The breath-taking identifier includes the rest symbol. The musical score file 610 is segmented into four musical score segments, namely, a musical score segment 610-1, a musical score segment 610-2, a musical score segment 610-3 and a musical score segment 610-4, according to the break-taking identifiers and rest symbols. Synthesizing the singing voice by segmenting the musical score file according to the breath-taking ports may avoid the phenomena such as breath-holding and long tone without a pause which occur in the traditional synthesis of the singing voice, and improve the user's experience.

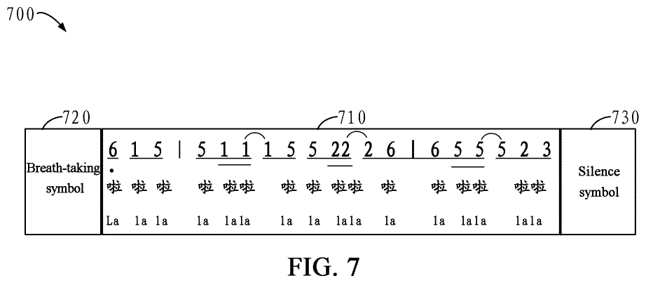

FIG. 7 illustrate a schematic diagram for adding 700 a symbol at both the beginning and ending of a musical score segment according to some embodiments of the present disclosure. Referring to FIG. 7, a breath-taking symbol segment 720 is added at the beginning and a silence symbol segment 730 is added at the ending of a musical score segment 710. In some embodiments, the length of the breath-taking symbol segment and the silence symbol segment may be determined according to the singing habit and rhythm of a real singer. For example, if the singer is inclined to take a deep breath to sing at the breath-taking point, the length of the breath-taking symbol segment is relatively longer. The act of adding the breath-taking symbol and the silence symbol may ensure that each musical score segment obtained by segmenting according to the breath-taking identifiers has a certain breath-taking effect after being synthesized into the audio segment, and the musical score segments resulting from the segmentation is more applicable for processing by the computing device.

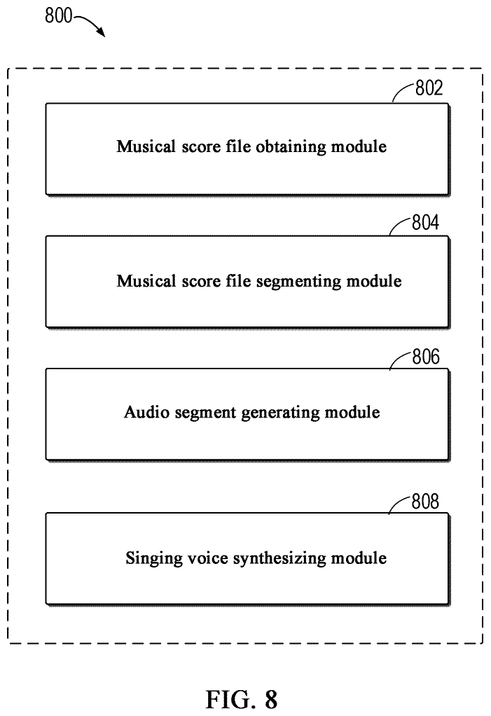

FIG. 8 illustrates a block diagram of an apparatus 800 for synthesizing a singing voice according to some embodiments of the present disclosure. As shown in FIG. 8, the apparatus 800 comprises a musical score file obtaining module 802 configured to obtain a musical score file with breath-taking identifiers. The apparatus 800 further comprises a musical score file segmenting module 804 configured to segment the musical score file into a plurality of musical score segments based on the breath-taking identifiers. The apparatus 800 further comprises an audio segment generating module 806 configured to generate a plurality of audio segments corresponding to the plurality of musical score segments. The apparatus further comprises a singing voice synthesizing module 808 configured to synthesize a singing voice corresponding to the musical score file based on the plurality of audio segments.

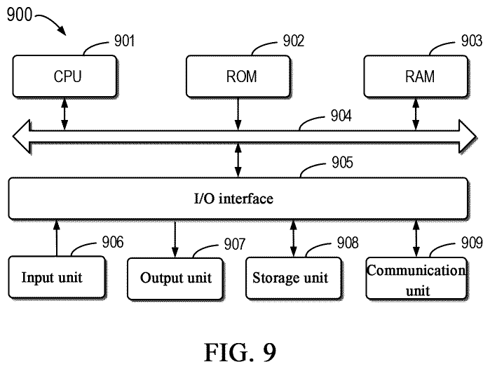

FIG. 9 illustrates a block diagram of an electronic device 900 according to an embodiment of the present disclosure. The device 900 may be a device or apparatus described in the embodiments of the present disclosure. As shown in FIG. 9, the device 900 comprises a Central Processing Unit (CPU) and/or a Graphics Processing Unit (GPU) 901 which may perform various suitable acts and processes in accordance with a computer program instruction stored in a Read Only Memory (ROM) 902 or a computer program instruction loaded from a storage unit 908 into a Random Access Memory (RAM) 903. In the RAM 903, various programs and data needed by the operation of the electronic device 900 are also stored. The CPU/GPU 901, the ROM 902, and the RAM 903 are connected to one another via a bus 904. An input/output (I/O) interface 905 is also coupled to bus 904. Although not shown in FIG. 9, the apparatus 900 may further comprise a coprocessor.

A plurality of components in the device 900 are connected to the I/O interface 905, and include: an input unit 906, such as a keyboard, a mouse, etc.; an output unit 907 such as various types of displays, speakers, and the like; a storage unit 908, such as a magnetic disk, an optical disk, etc.; and a communication unit 909 such as a network card, a modem, a wireless communication transceiver, etc. The communication unit 909 allows the device 900 to exchange information/data with other devices over a computer network such as the Internet and/or various telecommunication networks.

The various methods or processes described above may be performed by CPU/GPU 901. For example, in some embodiments, the method may be implemented as a computer software program tangibly embodied on a machine-readable medium, such as storage unit 908. In some embodiments, part or all of the computer program may be loaded and/or installed on the device 900 via ROM 902 and/or communication unit 909. One or more steps or acts in the methods or processes described above may be performed when the computer program is loaded into the RAM 903 and executed by the CPU/GPU 901.

In some embodiments, the methods and processes described above may be implemented as a computer program product. The computer program product may include a computer readable storage medium having computer readable program instructions embodied thereon for performing various aspects of the present disclosure.

The computer-readable storage medium may be a tangible device that can hold and store instructions for use by an instruction execution device. The computer readable storage medium may be, for example but not limited to, an electrical storage device, a magnetic storage device, an optical storage device, an electromagnetic storage device, a semiconductor storage device, or any suitable combination of the above. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the case of the remote computer, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to perform aspects of the present disclosure.

These computer readable program instructions may be provided to a processing unit of a general-purpose computer, special-purpose computer, or other programmable data processing apparatus to produce a machine, such that the instructions, which executed via the processing unit of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions executed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Some example implementations of the present disclosure are listed below.

Example 1. A method for synthesizing a singing voice, comprising:
obtaining a musical score file with breath-taking identifiers;
segmenting the musical score file into a plurality of musical score segments based on the breath-taking identifiers;
generating a plurality of audio segments corresponding to the plurality of musical score segments; and
synthesizing a singing voice corresponding to the musical score file based on the plurality of audio segments.

Example 2. The method according to Example 1, wherein the obtaining a musical score file with breath-taking identifiers comprises:
receiving the musical score file marked with the breath-taking identifiers.

Example 3. The method according to any of Examples 1-2, wherein the obtaining a musical score file with breath-taking identifiers comprises:
determining the breath-taking identifiers through a breath-taking identifier prediction model, the breath-taking identifier prediction model at least comprising a converter layer, a multi-layer convolution layer, and a linear layer.

Example 4. The method according to any of Examples 1-3, wherein the determining the breath-taking identifiers through a breath-taking identifier prediction model comprises:
extracting phoneme features, musical note features and lyrics features associated with the musical score file by parsing the musical score file;
determining a phoneme sequence of the musical score file based on the phoneme features, the musical note features and the lyrics features, the phoneme sequence at least comprising the breath-taking identifiers; and
obtaining the musical score file with the breath-taking identifiers based on the phoneme sequence.

Example 5. The method according to any of Examples 1-4, further comprising:
training the breath-taking identifier prediction model based on a plurality of musical score files marked with the breath-taking identifiers.

Example 6. The method according to any of Examples 1-5, wherein the training the breath-taking identifier prediction model based on a plurality of musical score files marked with the breath-taking identifiers comprises:
inputting the musical score file not marked with the breath-taking identifiers into the breath-taking identifier prediction model;
generating a phoneme sequence including the breath-taking identifiers; and
adjusting parameters of the breath-taking identifier prediction model based on a loss between the generated phoneme sequence and an annotated sequence, the annotated phoneme sequence being obtained based on the musical score file marked with the breath-taking identifiers.

Example 7. The method according to any of Examples 1-6, further comprising:
generating the breath-taking identifier prediction model in response to the loss satisfying a loss convergence condition.

Example 8. The method according to any of Examples 1-7, wherein the inputting the musical score files not marked with the breath-taking identifiers into the breath-taking identifier prediction model comprises:
parsing the musical score file not marked with the breath-taking identifiers;
extracting phoneme features, musical note features and lyrics features of the musical score file not marked with the breath-taking identifiers; and
inputting the phoneme features, the musical note features and the lyrics features into the breath-taking identifier prediction model in an embedded manner.

Example 9. The method according to any of Examples 1-8, further comprising:
adding a breath-taking symbol segment at the beginning of each musical score segment in the plurality of musical score segments; and
adding a silence symbol segment at the ending of each musical score segment in the plurality of musical score segments.

Example 10. The method according to any of Examples 1-9, wherein the synthesizing a singing voice corresponding to the musical score file based on the plurality of audio segments comprises:
concatenating the plurality of audio segments based on a pre-defined concatenation policy; and
synthesizing the singing voice corresponding to the musical score file based on the concatenated plurality of audio segments.

Example 11. The method according to any of Examples 1-10, wherein the concatenating the plurality of audio segments based on a pre-defined concatenation policy comprises:
in response to a long tone at the ending of a first audio segment, enabling a breath-taking symbol segment of a second audio segment to cover part of the long tone segment of the first audio segment, the first audio segment preceding the second audio segment;
in response to a third audio segment being a singing voice and a fourth audio segment being a singing voice which is continuous, superimposing the breath-taking symbol segment of the fourth audio segment on a silence symbol segment of the third audio segment, the third audio segment preceding the fourth audio segment; and
in response to a rest symbol being at the ending of a fifth audio segment, enabling the breath-taking symbol segment of a sixth audio segment to partly cover part of the rest symbol segment of the fifth audio segment, the fifth audio segment preceding the sixth audio segment.

Example 12. The method according to any of Examples 1-11, wherein the generating a plurality of audio segments corresponding to the plurality of musical score segments comprises:
parsing the musical score segments in the plurality of musical score segments;
based on the parsed musical score segments, extracting phoneme features at least including a pitch, a duration and an intensity;
determining a phoneme sequence of the musical score segments based on the phoneme features, the phoneme sequence indicating interval information of adjacent phonemes;
determining spectrum features of the musical score segments based on the phoneme features; and
determining audio segments of the musical score segments at least based on the spectrum features and the phoneme sequence.

Example 13. The method according to any of Examples 1-12, further comprising:
segmenting lyrics of the musical score segment into individual words;
determining parts of speech of the individual words based on the individual words; and
determining the phoneme sequence of the individual words based on the individual words and the parts of speech.

Example 14. An apparatus for synthesizing a singing voice, comprising:
a musical score file obtaining module configured to obtain a musical score file with breath-taking identifiers;
a musical score file segmenting module configured to segment the musical score file into a plurality of musical score segments based on the breath-taking identifiers;
an audio segment generating module configured to generate a plurality of audio segments corresponding to the plurality of musical score segments; and
a singing voice synthesizing module configured to synthesize a singing voice corresponding to the musical score file based on the plurality of audio segments.

Example 15. The apparatus according to Example 14, wherein the musical score file obtaining module comprises:
a musical score file receiving module configured to receive the musical score file marked with the breath-taking identifiers.

Example 16. The apparatus according to any of Examples 14-15, wherein the musical score file obtaining module comprises:
a breath-taking identifier determining module configured to determine the breath-taking identifiers through a breath-taking identifier prediction model, the breath-taking identifier prediction model at least comprising a converter layer, a multi-layer convolution layer, and a linear layer.

Example 17. The apparatus according to any of Examples 14-16, wherein the breath-taking identifier determining module comprises:
a feature extracting module configured to extract phoneme features, musical note features and lyrics features associated with the musical score file by parsing the musical score file;
a phoneme sequence determining module configured to determine a phoneme sequence of the musical score file based on the phoneme features, the musical note features and the lyrics features, the phoneme sequence at least comprising the breath-taking identifiers; and
a module for obtaining the musical score file with the breath-taking identifiers configured to obtain the musical score file with the breath-taking identifiers based on the phoneme sequence.

Example 18. The apparatus according to any of Examples 14-17, further comprising:
a breath-taking identifier prediction module training module configured to train the breath-taking identifier prediction model based on a plurality of musical score files marked with the breath-taking identifiers.

Example 19. The apparatus according to any of Examples 14-18, wherein the breath-taking identifier prediction module training module comprises:
a module for inputting a musical score file not marked with the breath-taking identifiers, configured to inputting the musical score file not marked with the breath-taking identifiers into the breath-taking identifier prediction model;
a module for generating a phoneme sequence having the breath-taking identifiers, configured to generate a phoneme sequence including the breath-taking identifiers; and
a module for adjusting parameters of the breath-taking identifier prediction module, configured to adjust parameters of the breath-taking identifier prediction model based on a loss between the generated phoneme sequence and an annotated sequence, the annotated phoneme sequence being obtained based on the musical score file marked with the breath-taking identifiers.

Example 20. The apparatus according to any of Examples 14-19, further comprising:
a breath-taking identifier prediction model generating module configured to generate the breath-taking identifier prediction model in response to the loss satisfying a loss convergence condition.

Example 21. The apparatus according to any of Examples 14-20, wherein the module for inputting a musical score file not marked with the breath-taking identifiers comprises:
a musical score file parsing module configured to parse the musical score file not marked with the breath-taking identifiers;
a feature extracting module configured to extract phoneme features, musical note features and lyrics features of the musical score file not marked with the breath-taking identifiers; and
a feature embedding module configured to input the phoneme features, the musical note features and the lyrics features into the breath-taking identifier prediction model in an embedded manner.

Example 22. The apparatus according to any of Examples 14-21, further comprising:
a breath-taking symbol segment adding module configured to add a breath-taking symbol segment at the beginning of each musical score segment in the plurality of musical score segments; and
a silence symbol segment adding module configured to add a silence symbol segment at the ending of each musical score segment in the plurality of musical score segments.

Example 23. The apparatus according to any of Examples 14-22, wherein the singing voice synthesizing module comprises:
an audio concatenating module configured to concatenate the plurality of audio segments based on a pre-defined concatenation policy; and
a singing voice synthesizing module corresponding to the musical score filed, configured to synthesize the singing voice corresponding to the musical score file based on the concatenated plurality of audio segments.

Example 24. The apparatus according to any of Examples 14-23, wherein the audio concatenating module comprises:
a breath-taking symbol covering module configured to, in response to a long tone at the ending of a first audio segment, enable a breath-taking symbol segment of a second audio segment to cover part of the long tone segment of the first audio segment, the first audio segment preceding the second audio segment;
a breath-taking symbol segment superimposing module configured to, in response to a third audio segment being a singing voice and a fourth audio segment being a singing voice which is continuous, superimpose the breath-taking symbol segment of the fourth audio segment on a silence symbol segment of the third audio segment, the third audio segment preceding the fourth audio segment; and
a breath-taking symbol partial covering module configured to, in response to a rest symbol being at the ending of a fifth audio segment, enable the breath-taking symbol segment of a sixth audio segment to partly cover part of the rest symbol segment of the fifth audio segment, the fifth audio segment preceding the sixth audio segment.

Example 25. The apparatus according to any of Examples 14-24, wherein the audio segment generating module comprises:
a musical score segment parsing module configured to parse the musical score segments in the plurality of musical score segments;
a feature extracting module configured to, based on the parsed musical score segments, extract phoneme features at least including a pitch, a duration and an intensity;
a phoneme sequence determining module configured to determining a phoneme sequence of the musical score segments based on the phoneme features, the phoneme sequence indicating interval information of adjacent phonemes;
a spectrum feature determining module configured to determine spectrum features of the musical score segments based on the phoneme features; and
an audio segment determining module configured to determine audio segments of the musical score segments at least based on the spectrum features and the phoneme sequence.

Example 26. The apparatus according to any of Examples 14-25, further comprising:
a lyric segmenting module configured to segment lyrics of the musical score segment into individual words;
a part of speech determining module configured to determine parts of speech of the individual words based on the individual words; and
a module for determining a phoneme sequence of individual words, configured determine the phoneme sequence of the individual words based on the individual words and the parts of speech.

Example 27. An electronic device, comprising:
a processor; and
a memory coupled to the processor, the memory having stored therein instructions that, when executed by the processor, cause the electronic device to perform acts, the acts comprising:
obtaining a musical score file with breath-taking identifiers;
segmenting the musical score file into a plurality of musical score segments based on the breath-taking identifiers;
generating a plurality of audio segments corresponding to the plurality of musical score segments; and
synthesizing a singing voice corresponding to the musical score file based on the plurality of audio segments.

Example 28. The electronic device according to Example 27, wherein the obtaining a musical score file with breath-taking identifiers comprises:
receiving the musical score file marked with the breath-taking identifiers.

Example 29. The electronic device according to any of Examples 27-28, wherein the obtaining a musical score file with breath-taking identifiers comprises:
determining the breath-taking identifiers through a breath-taking identifier prediction model, the breath-taking identifier prediction model at least comprising a converter layer, a multi-layer convolution layer, and a linear layer.

Example 30. The electronic device according to any of Examples 27-29, wherein the determining the breath-taking identifiers through a breath-taking identifier prediction model comprises:
extracting phoneme features, musical note features and lyrics features associated with the musical score file by parsing the musical score file;
determining a phoneme sequence of the musical score file based on the phoneme features, the musical note features and the lyrics features, the phoneme sequence at least comprising the breath-taking identifiers; and
obtaining the musical score file with the breath-taking identifiers based on the phoneme sequence.

Example 31. The electronic device according to any of Examples 27-30, further comprising:
training the breath-taking identifier prediction model based on a plurality of musical score files marked with the breath-taking identifiers.

Example 32. The electronic device according to any of Examples 27-31, wherein the training the breath-taking identifier prediction model based on a plurality of musical score files marked with the breath-taking identifiers comprises:
inputting the musical score file not marked with the breath-taking identifiers into the breath-taking identifier prediction model;
generating a phoneme sequence including the breath-taking identifiers; and
adjusting parameters of the breath-taking identifier prediction model based on a loss between the generated phoneme sequence and an annotated sequence, the annotated phoneme sequence being obtained based on the musical score file marked with the breath-taking identifiers.

Example 33. The electronic device according to any of Examples 27-32, the acts further comprising:
generating the breath-taking identifier prediction model in response to the loss satisfying a loss convergence condition.

Example 34. The electronic device according to any of Examples 27-33, wherein the inputting the musical score files not marked with the breath-taking identifiers into the breath-taking identifier prediction model comprises:
parsing the musical score file not marked with the breath-taking identifiers;
extracting phoneme features, musical note features and lyrics features of the musical score file not marked with the breath-taking identifiers; and
inputting the phoneme features, the musical note features and the lyrics features into the breath-taking identifier prediction model in an embedded manner.

Example 35. The electronic device according to any of Examples 27-34, the acts further comprising:
adding a breath-taking symbol segment at the beginning of each musical score segment in the plurality of musical score segments; and
adding a silence symbol segment at the ending of each musical score segment in the plurality of musical score segments.

Example 36. The electronic device according to any of Examples 27-35, wherein the synthesizing a singing voice corresponding to the musical score file based on the plurality of audio segments comprises:
concatenating the plurality of audio segments based on a pre-defined concatenation policy; and
synthesizing the singing voice corresponding to the musical score file based on the concatenated plurality of audio segments.

Example 37. The electronic device according to any of Examples 27-36, wherein the concatenating the plurality of audio segments based on a pre-defined concatenation policy comprises:
in response to a long tone at the ending of a first audio segment, enabling a breath-taking symbol segment of a second audio segment to cover part of the long tone segment of the first audio segment, the first audio segment preceding the second audio segment;
in response to a third audio segment being a singing voice and a fourth audio segment being a singing voice which is continuous, superimposing the breath-taking symbol segment of the fourth audio segment on a silence symbol segment of the third audio segment, the third audio segment preceding the fourth audio segment; and
in response to a rest symbol being at the ending of a fifth audio segment, enabling the breath-taking symbol segment of a sixth audio segment to partly cover part of the rest symbol segment of the fifth audio segment, the fifth audio segment preceding the sixth audio segment.

Example 38. The electronic device according to any of Examples 27-37, wherein the generating a plurality of audio segments corresponding to the plurality of musical score segments comprises:
parsing the musical score segments in the plurality of musical score segments;
based on the parsed musical score segments, extracting phoneme features at least including a pitch, a duration and an intensity;
determining a phoneme sequence of the musical score segments based on the phoneme features, the phoneme sequence indicating interval information of adjacent phonemes;
determining spectrum features of the musical score segments based on the phoneme features; and
determining audio segments of the musical score segments at least based on the spectrum features and the phoneme sequence.

Example 39. The electronic device according to any of Examples 27-38, the acts further comprising:
segmenting lyrics of the musical score segment into individual words;
determining parts of speech of the individual words based on the individual words; and
determining the phoneme sequence of the individual words based on the individual words and the parts of speech.

Example 40. A computer-readable storage medium having stored thereon computer-executable instructions, wherein the computer-executable instructions are executed by a processor to implement the method according to any of Examples 1 to 13.

Example 41. A computer program product tangibly stored on a computer-readable medium and comprising computer-executable instructions that, when executed by an apparatus, cause the apparatus to perform the method according to any of Examples 1 to 13.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

I/we claim:

1. A method for synthesizing a singing voice, comprising:
obtaining a musical score file with breath-taking identifiers;
segmenting the musical score file into a plurality of musical score segments based on the breath-taking identifiers;
generating a plurality of audio segments corresponding to the plurality of musical score segments; and
synthesizing a singing voice corresponding to the musical score file based on the plurality of audio segments.

2. The method according to claim 1, wherein the obtaining a musical score file with breath-taking identifiers comprises:
receiving the musical score file marked with the breath-taking identifiers.

3. The method according to claim 1, wherein the obtaining a musical score file with breath-taking identifiers comprises:
determining the breath-taking identifiers through a breath-taking identifier prediction model, the breath-taking identifier prediction model at least comprising a converter layer, a multi-layer convolution layer, and a linear layer.

4. The method according to claim 3, wherein the determining the breath-taking identifiers through a breath-taking identifier prediction model comprises:
extracting phoneme features, musical note features and lyrics features associated with the musical score file by parsing the musical score file;
determining a phoneme sequence of the musical score file based on the phoneme features, the musical note features and the lyrics features, the phoneme sequence at least comprising the breath-taking identifiers; and
obtaining the musical score file with the breath-taking identifiers based on the phoneme sequence.

5. The method according to claim 3, further comprising:
training the breath-taking identifier prediction model based on a plurality of musical score files marked with the breath-taking identifiers.

6. The method according to claim 5, wherein the training the breath-taking identifier prediction model based on a plurality of musical score files marked with the breath-taking identifiers comprises:
inputting the musical score file not marked with the breath-taking identifiers into the breath-taking identifier prediction model;
generating a phoneme sequence including the breath-taking identifiers; and
adjusting parameters of the breath-taking identifier prediction model based on a loss between the generated phoneme sequence and an annotated phoneme sequence, the annotated phoneme sequence being obtained based on the musical score file marked with the breath-taking identifiers.

7. The method according to claim 6, further comprising:
generating the breath-taking identifier prediction model in response to the loss satisfying a loss convergence condition.

8. The method according to claim 6, wherein the inputting the musical score files not marked with the breath-taking identifiers into the breath-taking identifier prediction model comprises:
parsing the musical score file not marked with the breath-taking identifiers;
extracting phoneme features, musical note features and lyrics features of the musical score file not marked with the breath-taking identifiers; and
inputting embeddings of the phoneme features, the musical note features and the lyrics features into the breath-taking identifier prediction model.

9. The method according to claim 1, further comprising:
adding a breath-taking symbol segment at the beginning of each musical score segment in the plurality of musical score segments; and
adding a silence symbol segment at the ending of each musical score segment in the plurality of musical score segments.

10. The method according to claim 1, wherein the synthesizing a singing voice corresponding to the musical score file based on the plurality of audio segments comprises:
concatenating the plurality of audio segments based on a pre-defined concatenation policy; and
synthesizing the singing voice corresponding to the musical score file based on the concatenated plurality of audio segments.

11. The method according to claim 10, wherein the concatenating the plurality of audio segments based on a pre-defined concatenation policy comprises:
in response to the ending of a first audio segment being a long tone, enabling a breath-taking symbol segment of a second audio segment to cover a part of a long tone segment of the first audio segment, the first audio segment preceding the second audio segment;
in response to a third audio segment being a singing voice and a fourth audio segment being a singing voice which is continuous, superimposing a breath-taking symbol segment of the fourth audio segment on a silence symbol segment of the third audio segment, the third audio segment preceding the fourth audio segment; and
in response to the ending of a fifth audio segment being a rest symbol, enabling a breath-taking symbol segment of a sixth audio segment to partly cover a part of a rest symbol segment of the fifth audio segment, the fifth audio segment preceding the sixth audio segment.

12. The method according to claim 1, wherein the generating a plurality of audio segments corresponding to the plurality of musical score segments comprises:
parsing a musical score segment in the plurality of musical score segments;
extracting, based on the parsed musical score segment, phoneme features at least including a pitch, a duration and an intensity;
determining a phoneme sequence of the musical score segment based on the phoneme features, the phoneme sequence indicating interval information of adjacent phonemes;
determining spectrum features of the musical score segment based on the phoneme features; and
determining an audio segment of the musical score segment at least based on the spectrum features and the phoneme sequence.

13. The method according to claim 12, further comprising:
segmenting lyrics of the musical score segment into individual words;
determining parts of speech of the individual words based on the individual words; and
determining a phoneme sequence of the individual words based on the individual words and the parts of speech.

14. An electronic device, comprising:
a processor; and
a memory coupled to the processor, the memory having stored therein instructions that, when executed by the processor, cause the electronic device to:
obtain a musical score file with breath-taking identifiers;
segment the musical score file into a plurality of musical score segments based on the breath-taking identifiers;
generate a plurality of audio segments corresponding to the plurality of musical score segments; and
synthesize a singing voice corresponding to the musical score file based on the plurality of audio segments.

15. The electronic device according to claim 14, wherein the instructions causing the electronic device to obtain a musical score file with breath-taking identifiers further cause the electronic device to:
receive the musical score file marked with the breath-taking identifiers.

16. The electronic device according to claim 14, wherein the instructions causing the electronic device to obtain a musical score file with breath-taking identifiers further cause the electronic device to:
determine the breath-taking identifiers through a breath-taking identifier prediction model, the breath-taking identifier prediction model at least comprising a converter layer, a multi-layer convolution layer, and a linear layer.

17. The electronic device according to claim 16, wherein the instructions causing the electronic device to determine the breath-taking identifiers through a breath-taking identifier prediction model further cause the electronic device to:
extract phoneme features, musical note features and lyrics features associated with the musical score file by parsing the musical score file;
determine a phoneme sequence of the musical score file based on the phoneme features, the musical note features and the lyrics features, the phoneme sequence at least comprising the breath-taking identifiers; and
obtain the musical score file with the breath-taking identifiers based on the phoneme sequence.

18. The electronic device according to claim 16, wherein the instructions further cause the electronic device to:
train the breath-taking identifier prediction model based on a plurality of musical score files marked with the breath-taking identifiers.

19. The electronic device according to claim 18, wherein the instructions causing the electronic device to train the breath-taking identifier prediction model based on a plurality of musical score files marked with the breath-taking identifiers further cause the electronic device to:
input the musical score file not marked with the breath-taking identifiers into the breath-taking identifier prediction model;
generate a phoneme sequence including the breath-taking identifiers; and
adjust parameters of the breath-taking identifier prediction model based on a loss between the generated phoneme sequence and an annotated phoneme sequence, the annotated phoneme sequence being obtained based on the musical score file marked with the breath-taking identifiers.

20. A non-transitory storage medium containing computer-executable instructions, when executed by a computer processor, the computer-executable instructions cause the computer processor to:
obtain a musical score file with breath-taking identifiers;
segment the musical score file into a plurality of musical score segments based on the breath-taking identifiers;
generate a plurality of audio segments corresponding to the plurality of musical score segments; and
synthesize a singing voice corresponding to the musical score file based on the plurality of audio segments.
